(19) United States
(12) Patent Application Publication
(10) Pub. No.: US 2005/0041376 A1
(43) Pub. Date: Feb. 24, 2005

(54) Flexible connector module and modular system for measuring and transferring sensor signals

(76) Inventors: Jan Hendrik Johan Peuscher, Enschede (NL); Bianca Georgette Scholten, NL-7554 PR Hengelo (NL)

Correspondence Address: Richard L. Byrne, 700 Koppers Building, 436 Seventh Avenue, Pittsburgh, PA, 15219-1818, US

(21) Appl. No.: 10/486,212

(22) PCT Filed: Aug. 8, 2002
(86) PCT No.: PCT/NL02/00535

(30) Foreign Application Priority Data
Aug. 9, 2001 (NL) 1018729

(51) Int. Cl. H02B 1/00

(52) U.S. Cl. 361/600

(57) ABSTRACT

The invention relates to a connector module for a measuring system, which connector module comprises:—a number of sensor connections placed mutually adjacently in a single row;—a connecting cable having at least one plug and connected to the sensor connections; wherein the sensor connections and at least a part of the connecting cable are embedded in a flexible material. The invention further relates to a modular system for measuring and transferring sensor signals to a monitor unit, which system comprises; —a basic module for connecting to the monitor unit; and at least one amplifier module for amplifying the sensor signals; wherein the modules are electrically connected to each other by means of a bus system.

The invention comprises a connector module for a measuring system, more particularly a connector module coupled to a modular universal measuring system for measuring and transferring sensor signals to a monitor unit.

When deciding on a plan of treatment, for instance for epilepsy, it is necessary first of all to measure the activity of the brain prior to and during an epileptic attack. A large number of sensors are arranged for this purpose on the cranium of the patient, and the sensor signals derived therefrom are recorded for a long period. In some cases operatively invasive electrodes are also arranged. When an epileptic attack now occurs, it is then possible to determine which parts of the brain cause the epileptic attack and a plan of treatment can thus be decided upon.

In prior art systems, wherein the connections are integrated into the whole system, diverse rows of sensor connections are used to keep the whole system as compact as possible. The drawback hereof is that it is very difficult to select a connecting cable of a sensor from a row of sensor connections that lies between adjacent rows and to disconnect or reconnect this cable. What can for instance occur is that the patient accidentally pulls,loose one of the connecting cables of a sensor or that a sensor fails, for instance due to the cable breaking. This must then be reconnected or replaced In addition, the current systems are not flexible, so that they cannot adapt to the shape of the body of the wearer.

It is an object of the invention to alleviate these drawbacks with a flexible connector module which comprises:
a number of sensor connections placed mutually adjacently in a single row;
a connecting cable having at least one plug and connected to the sensor connections;

wherein the sensor connections and at least a part of the connecting cable are embedded in a flexible material.

Because the sensor connections are placed mutually adjacently in a single row, each sensor connection can be accessed easily. By then embedding the whole in a flexible material it becomes possible to wear the connector module against the body without this being perceived as irritating. Such a connector module can for instance be worn on the chest or on the shoulder. This gives the additional advantage that the connector module can thus be placed close to the measuring points of the sensors, whereby the separate cables of each sensor to the connector module can be kept as short as possible. Interference resulting from displacements of the sensor wires relative to each other are hereby reduced. Amplifiers and related electronics can further be situated in the connector module, thereby eliminating interference between the connector module and the modular system.

The single plug of the connecting cable is preferably connectable to an amplifier module of a modular system according to the invention. Standardized components can thus be readily used to construct a system with which the sensor signals can be amplified and processed. The number of signals which can be processed per module is preferably 32.

The invention also relates to a modular universal system for measuring and transferring sensor signals to a monitor unit.

The number of sensors used to perform the measurements can vary from a few sensors to as many as hundreds. The signals measured with these sensors are very small and, as mentioned above, it is therefore important for these signals to be already amplified close to the measuring point in respect of interference. These signals are then digitized to enable transfer to a monitor unit. This entails the patient having to carry with him/her the amplifiers and analog/digital converters for the signals, and a flexible system is therefore desired so that the weight of the system can be easily minimized and adapted to the patient.

It is an object of the invention to provide a system which implements the above stated objectives.

This object is achieved with a modular system according to the invention, which system comprises:
a basic module for connecting to the monitor unit and transferring the sensor signals thereto; and
at least one amplifier module for amplifying the sensor signals;

wherein the modules are electrically connected to each other by means of a bus system.

Because the modules are electrically connected to each other by means of a bus system, it is possible to connect a random number of modules to each other. This is because the bus system makes it possible to address the different modules individually, whereby they can exchange data between each other and can thus transfer the amplified sensor signals to the basic module, which subsequently transfers these signals to the monitor unit. Modules for storage, power supply or telemetry can further be connected to the basic module.

In a first embodiment the modular system according to the invention comprises a basic module with a cable connection with which the sensor signals can be transferred to the monitor unit and with which the modular system can be supplied with energy, coupled to at least one amplifier module for amplifying the sensor signals.

In a second embodiment the modular system according to the invention also comprises a storage module for storing the sensor signals, with which it is possible to first store signals temporarily and to only transmit these signals after a determined time to the basic module, with which they can be fed to the monitor unit. The modular system according to the invention preferably further comprises a battery module to supply the modular system temporarily with power.

This embodiment is particularly important in those cases where the patient temporarily requires more freedom of movement than the cable length allows, and the connection to the monitor unit has to be interrupted temporarily.

In a third embodiment the modular system according to the invention comprises a battery module and a storage module with which it is possible to store the measured sensor signals for a longer period and to have these signals read at a later point in time by the monitor unit. This is an advantageous embodiment particularly when there is no cable connection between the modular system and the monitor unit.

In a fourth embodiment the modular system according to the invention also comprises a transfer module which can be connected to the basic module for wireless connection of the basic module to the monitor unit, so that the basic module can transfer the signals to the monitor unit via this transfer module. This is a preferred embodiment, since the patient hereby obtains a considerable freedom of movement. The patient then no longer has to take account of the length of the connecting cable and can therefore do as he/she pleases, as long as he/she remains within the range of the remote connection.

A fifth embodiment of the invention further comprises a storage module for temporarily storing the signals. This embodiment is particularly important in those cases where the patient moves temporarily outside the range of the remote connection. Once this connection has been reestablished, the stored signals can then still be fed to the monitor unit.

In a sixth embodiment the modular system according to the invention comprises at least one connector module for connecting each of the sensors individually to the system. In the case of invasively arranged sensors, only a single cable normally has to be connected to the modular system. When however separate sensors are used, which are for instance adhered to the skin of the head, each sensor must then be connected separately to the modular system. It is recommended in such a case to provide a connector module to which the sensors can be individually connected.

These and other features of the invention are further elucidated with reference to the annexed drawings.

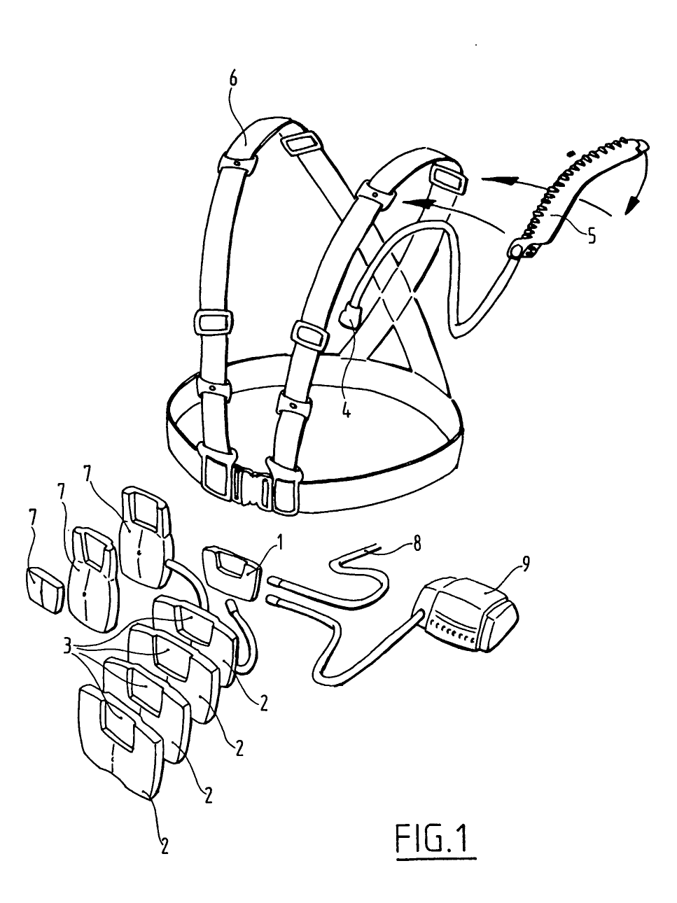

FIG. 1 shows a perspective view of a modular system according to the invention.

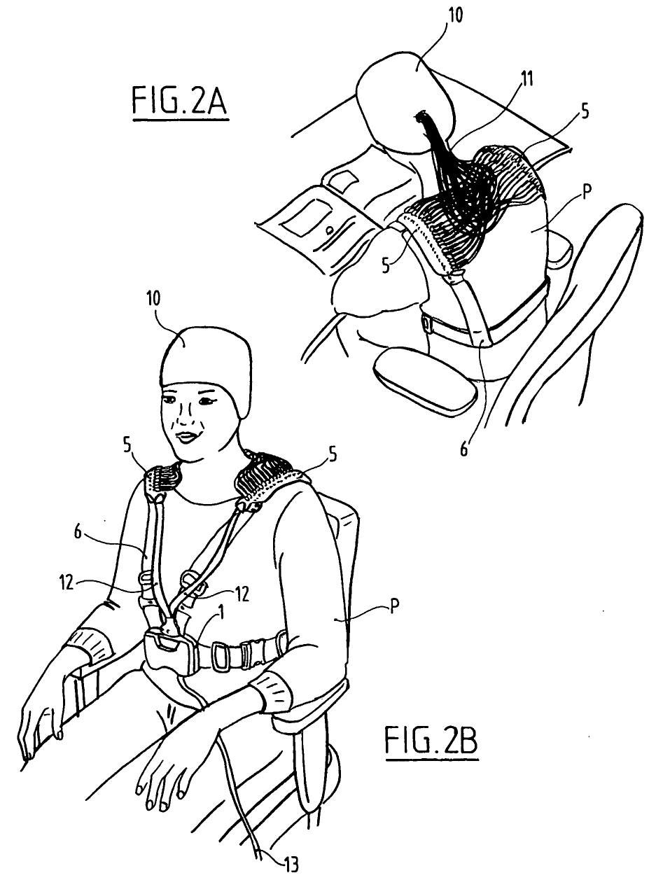

FIGS. 2A and 2B show a patient who is wearing the connector module and the modular system as according to FIG. 1.

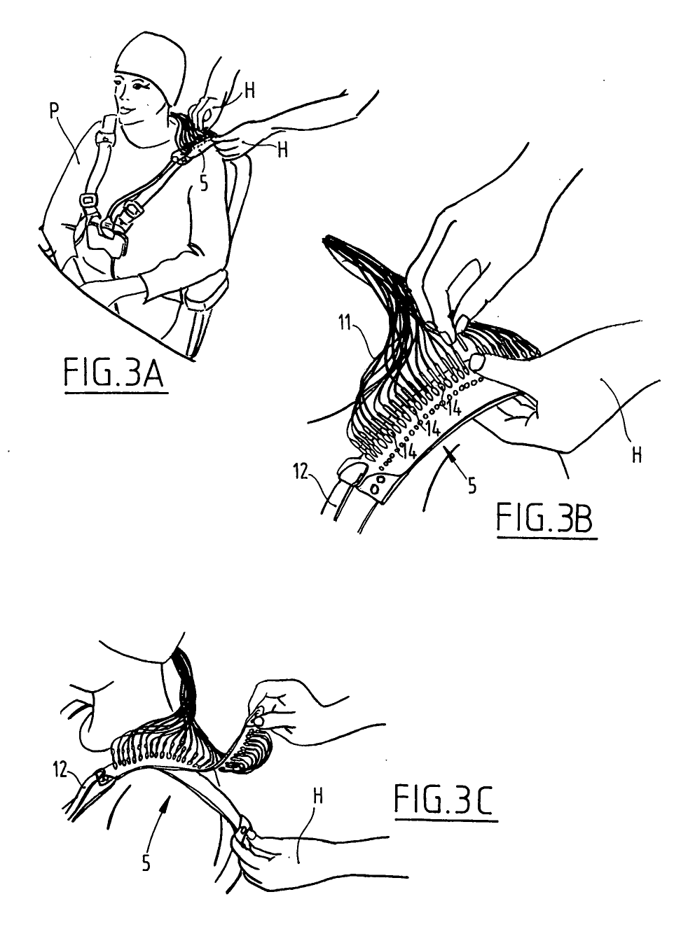

FIGS. 3A to 3C show the different operations relating to the connector module according to the invention.

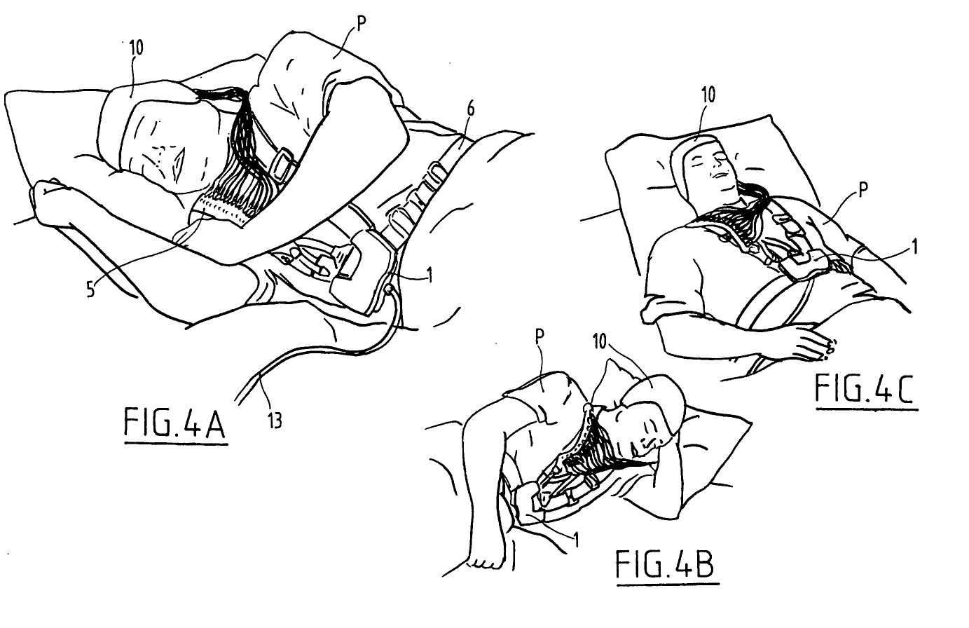

FIGS. 4A to 4C show a patient with the connector module and the modular system in different positions.

FIG. 1 shows a modular system according to the invention. This modular system consists of a basic module 1 on which is placed at least one amplifier unit 2. This amplifier module 2 has a connection 3 for a plug 4 of a connector module 5. The system of basic module 1 and amplifier module 2 can be arranged on a harness 6 which the patient can put on so as to thus carry with him/her the modular system according to the invention. A third module 7 can be placed as desired on basic module 1 and amplifier module 2. This may for instance be a second amplifier module 2 for an additional connector module, but it may also contain a battery, storage means for temporary storage of the sensor signals or connecting means for wireless connection to the monitor unit, or a combination thereof. Basic module 1 can be connected directly to the monitor unit with a cable 8 but, as stated above, the third module 7 can also be a transfer module with which a wireless connection can be established. Connecting cable 8 can then be omitted or used as desired to connect a plurality of modules in addition to the basic module. It is recommended here that a battery module is also arranged. An input module can further be arranged on basic module 1 to connect extra measuring means to the system and also transfer the signals therefrom to the monitor unit. A pulse oximeter can be envisaged here for measuring oxygen in the blood, the blood circulation and pulse rate, or movement sensors.

FIGS. 2A and 2B show a patient P who has on the harness 6. This harness 6 is fully adjustable so that it can be readily modified to the patient. Arranged on the cranium are sensors which are covered by means of a kind of bathing cap 10. Exiting to the outside at the rear are a large number of wires 11 which run to two connector modules 5. Since these connector modules 5 are arranged on the shoulders of patient P, this patient can move his/her head freely. Connector modules 5 are each coupled by means of a cable 12 to an amplifier module 2 which in turn are connected to each other and to basic module 1. This basic module 1 is connected to the monitor unit by means of a cable 13.

FIGS. 3A-3C show how someone can easily access connector module 5 with the hands H while the patient is wearing it normally. As shown in FIG. 3B, connector module 5 comprises a large number of sensor connections 14 which are placed mutually adjacently in a single row and to which the individual sensor connecting wires 11 are connected. These sensor connections 14 are embedded into a flexible material so that connector module 5 readily shapes itself to the body, whereby it can for instance be worn on the shoulder. It thus also becomes possible to disconnect the connector module 5 from the shoulder and, as shown in FIGS. 4A-4C, attach it at the front on the chest. In this way the patient P is not disturbed during sleep.

1-12. (cancelled).

13. A connector module for a measuring system, which connector module comprises:
a) a number of sensor connections placed mutually adjacently in a single row; and
b) a connecting cable having at least one plug and connected to the sensor connections,
wherein the sensor connections and at least a part of the connecting cable are embedded in a flexible material.

14. The connector module as claimed in claim 13, comprising at least one amplifier arranged in the connector module.

15. The connector module as claimed in claim 13, comprising a modular system for measuring and transferring sensor signals to a monitor unit, which system comprises:
a basic module for connecting to the monitor unit; and
at least one amplifier module for amplifying the sensor signals,
wherein the modules are electrically connected to each other by means of a bus system, and wherein the at least one plug is connected to the at least one amplifier module.

16. The connector module as claimed in claim 15, comprising a storage module connectable to the basic module for storing the measured sensor signals.

17. The connector module as claimed in claim 15, comprising a battery module connectable to the basic module to supply the modular system temporarily with power.

18.The connector module as claimed in claim 15, comprising a transfer module which can be connected to the basic module for wireless connection of the basic module to the monitor unit.

19. A modular system for measuring and transferring sensor signals to a monitor unit, which system comprises:
a) a basic module for connecting to the monitor unit; and
b) at least one amplifier module for amplifying the sensor signals,
wherein the modules are electrically connected to each other by means of a bus system.

20. The modular system as claimed in claim 19, comprising a storage module connectable to the basic module for storing the measured sensor signals.

21. The modular system as claimed in claim 19, comprising a battery module connectable to the basic module to supply the modular system temporarily with power.

22. The modular system as claimed in claim 19, comprising a transfer module which can be connected to the basic module for wireless connection of the basic module to the monitor unit.

23. The modular system as claimed in claim 13, comprising at least one connector module for connecting each of the sensors individually to the system.

24. The modular system as claimed in claim 23, wherein the connector module comprises:
c) a number of sensor connections placed mutually adjacently in a single row; and
d) a connecting cable having at least one plug and connected to the sensor connections,
wherein the sensor connections and at least a part of the connecting cable are embedded in a flexible material.

25. The modular system as claimed in claim 19, comprising at least one connector module for connecting each of the sensors individually to the system.

26. The modular system as claimed in claim 25, wherein the connector module comprises:
c) a number of sensor connections placed mutually adjacently in a single row; and
d) a connecting cable having at least one plug and connected to the sensor connections,
wherein the sensor connections and at least a part of the connecting cable are embedded in a flexible material.
